(19) United States
(12) Patent Application Publication
(10) Pub. No.: US 2021/0014130 A1
(43) Pub. Date: Jan. 14, 2021

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/746,988

(22) Filed: Jan. 20, 2020

(30) Foreign Application Priority Data
Jul. 8, 2019 (JP) 2019-126975

(51) Int. Cl. H04L 12/24; H04W 76/20; H04L 29/08; H04W 36/00; H04W 4/60

(52) U.S. Cl. CPC H04L 41/5006; H04W 76/20; H04W 4/60; H04W 36/0011; H04L 67/16

(57) ABSTRACT

An information processing apparatus includes a control section that in a case where a user who uses a specific place is a user who has reserved the specific place, changes communication contract information of a terminal apparatus used by the user, and causes the terminal apparatus to perform communication using the changed communication contract information, during a period of the reservation.

### CROSS-REFERENCE TO RELATED APPLICATIONS

This application is based on and claims priority under 35 USC 119 from Japanese Patent Application No. 2019-126975 filed Jul. 8, 2019.

### BACKGROUND

### (i) Technical Field

The present invention relates to an information processing apparatus and a non-transitory computer readable medium storing a program.

### (ii) Related Art

JP2008-033417A describes a SIM card including a communication unit that receives a specific signal, and a response signal generator that generates a response signal indicating the position of a subscriber identity module (SIM) card when the communication unit receives the specific signal.

### SUMMARY

Aspects of non-limiting embodiments of the present disclosure relate to an information processing apparatus and a non-transitory computer readable medium storing a program, which enable a user who uses a specific place to easily use a specific communication.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a control section that in a case where a user who uses a specific place is a user who has reserved the specific place, changes communication contract information of a terminal apparatus used by the user, and causes the terminal apparatus to perform communication using the changed communication contract information, during a period of the reservation.

### BRIEF DESCRIPTION OF THE DRAWINGS

Exemplary embodiment(s) of the present invention will be described in detail based on the following figures, wherein:

FIG. 1 is a block diagram illustrating a configuration of an information processing system according to the present exemplary embodiment;

FIG. 2 is a block diagram illustrating a configuration of a terminal apparatus according to the present exemplary embodiment;

FIG. 3 is a block diagram illustrating a configuration of a reservation management apparatus according to the present exemplary embodiment;

FIG. 4 is a block diagram illustrating a configuration of a control apparatus according to the present exemplary embodiment;

FIG. 5 is a diagram illustrating a reservation management table;

FIG. 6 is a diagram illustrating a screen;

FIG. 7 is a sequence diagram illustrating a flow of processing by the information processing system according to the present exemplary embodiment;

FIG. 8 is a diagram illustrating information stored in a SIM;

FIG. 9 is a diagram illustrating information stored in a SIM;

FIG. 10 is a diagram illustrating information stored in a SIM; and

FIG. 11 is a diagram illustrating information stored in a SIM.

### DETAILED DESCRIPTION

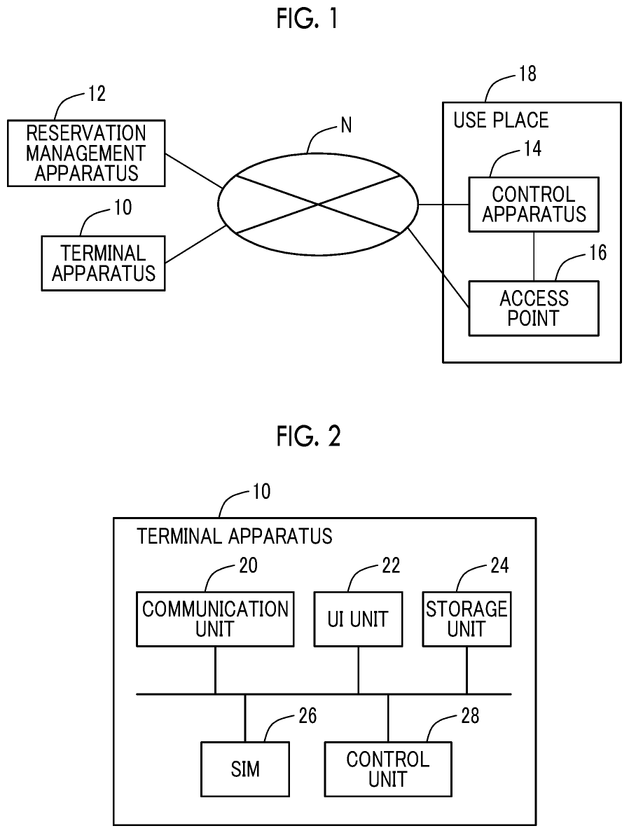

Hereinafter, an information processing system according to the present exemplary embodiment will be described with reference to FIG. 1. FIG. 1 illustrates an example of the configuration of the information processing system according to the present exemplary embodiment.

The information processing system according to the present exemplary embodiment includes one or a plurality of terminal apparatuses 10 and a reservation management apparatus 12. The information processing system according to the present exemplary embodiment may further include one or a plurality of control apparatuses 14 and one or a plurality of access points 16. Of course, the information processing system according to the present exemplary embodiment may not include the control apparatus 14 and the access point. The information processing system may include apparatuses other than these.

The terminal apparatus 10, the reservation management apparatus 12, the control apparatus 14, and the access point 16 may communicate with other apparatuses through the communication path N. The communication path N is, for example, a network such as a local area network (LAN) or the Internet. The communication path N may be established by wired communication or may be established by wireless communication such as Wi-Fi (registered trademark). The terminal apparatus 10, the reservation management apparatus 12, the control apparatus 14, and the access point 16 are connected to the communication path N using, for example, wireless communication or wired communication, and communicate with other apparatuses through the communication path N. The terminal apparatus 10, the reservation management apparatus 12, the control apparatus 14, and the access point 16 may communicate with other apparatuses using near field communication or the like without passing through the communication path N. Near field communication is, for example, Bluetooth (registered trademark), radio frequency identifier (RFID), NFC, or the like.

The terminal apparatus 10 is, for example, apparatuses such as a personal computer (hereinafter referred to as “PC”), a tablet PC, a smartphone, a mobile phone, or the like. As an example, the terminal apparatus 10 is a portable terminal apparatus such as a tablet PC, a smartphone, or a mobile phone.

The reservation management apparatus 12 is an apparatus configured to manage a reservation for use of the use place 18. For example, in a case where a period during which the use place 18 is available is reserved, the user who has made the reservation is permitted to use the use place 18 during the reserved period, and the user who has not made the reservation is not permitted to use the use place 18. The reservation period is determined by, for example, a date and a time zone.

The use place 18 is a place used by a person, for example, an office such as a booth and a shared office, a hotel room, a seat of a vehicle (for example, a car, a train, an airplane, or a bus), a part or all of a building, or a public place. The use place 18 may be an indoor place or an outdoor place. Of course, a place other than these may be the use place 18.

The reservation management apparatus 12 manages reservations for use of one or a plurality of use places 18. Each use place 18 is a different place, for example. For example, each booth is installed in a different place, and a reservation for use of each booth is made. The same applies to the other use places 18.

The control apparatus 14 is an apparatus configured to control wireless communication that is usable through the access point 16 at the use place 18. Of course, the control apparatus 14 may control wired communication that is usable at the use place 18. Further, the control apparatus 14 may manage entry and exit of a person to and from the use place 18.

The access point 16 is a wireless communication apparatus, and is an apparatus configured to wirelessly communicate with an apparatus (for example, the terminal apparatus 10) using the access point 16 and connect the apparatus to a communication path such as the communication path N. For example, one or a plurality of access points 16 is available for each use place 18. The access point 16 may be installed within the use place 18 or may be installed around the use place 18. For example, all or part of the use place 18 is included in a range of a place where communication using the access point 16 is possible (for example, a range of a place where a radio wave can be transmitted to and received from the access point 16). Thereby, wireless communication using the access point 16 can be performed in all or part of the use place 18.

The control apparatus 14 is installed, for example, within the use place 18 or around the use place 18 and controls the access point 16 that is available in the use place 18 to control wireless communication that is usable by the access point 16. For example, the control apparatus 14 and the access point 16 are connected by a wired communication path or a wireless communication path, and the control apparatus 14 controls the access point 16 through the wired communication path or the wireless communication path. In a case where the reservation management apparatus 12 manages reservations for use of a plurality of use places 18, the control apparatus 14 is installed at each use place 18, and for each use place 18, the access point 16 of the use place 18 is controlled by the control apparatus 14 installed in the use place 18. Of course, one control apparatus 14 may control a plurality of access points 16 (for example, access points 16 installed in each of a plurality of use places 18).

Hereinafter, the configuration of the terminal apparatus 10 will be described in detail with reference to FIG. 2. FIG. 2 shows an example of the configuration of the terminal apparatus 10.

The communication unit 20 is a communication interface, and has a function of transmitting information to other apparatuses and a function of receiving information from other apparatuses. The communication unit 20 may have a wireless communication function or may have a wired communication function. The communication unit 20 may be connected to the communication path N using wireless communication or wired communication, and communicate with other apparatuses through the communication path N. Alternatively, the communication unit 20 may use near field communication and communicate with other apparatuses without passing through the communication path N.

A UI unit 22 is a user interface, and includes a display unit and an operation unit. The display unit is a display device such as a liquid crystal display. The operation unit is an input device such as a keyboard, input keys, or an operation panel. The UI unit 22 may be a UI unit such as a touch panel that has both a display unit and an operation unit.

A storage unit 24 is one or a plurality of storage areas for storing various types of information. Each storage area is configured with, for example, one or a plurality of storage devices (for example, physical drives such as a hard disk drive and a memory) provided in the terminal apparatus 10.

A subscriber identity module (SIM) 26 is a subscriber authentication module that stores communication contract information, which is information necessary for the terminal apparatus 10 to perform communication. The communication contract information is information indicating a communication contract between a user (that is, a subscriber of a contract) who uses communication provided by the communication carrier and the communication carrier, and is, for example, information for performing communication using a mobile communication system (for example, a fourth-generation mobile communication system (that is, 4G) or a fifth-generation mobile communication system (that 5G)). Of course, the communication contract information may be information for performing communication using a communication system other than the above communication systems. For example, the communication contract information may be information for performing communication using Wi-Fi. The communication contract information includes, for example, a telephone number used for communication, identification information of the SIM 26 (for example, an IC Card Identifier (ICCID)), subscriber identification information (for example, international mobile subscriber identity (IMSI)), and the like. Further, the communication contract information may include communication carrier information. The communication unit 20 performs communication by using the information stored in the SIM 26.

A plurality of pieces of communication contract information may be stored in the SIM 26. For example, a plurality of pieces of communication contract information with different telephone numbers may be stored in the SIM 26. In this case, the communication unit 20 performs communication by using any one of a plurality of telephone numbers stored in the SIM 26. For example, communication contract information for communication in a certain country and communication contract information for communication in another country may be stored in the SIM 26, and the communication unit 20 may communicate by using communication contract information for each country.

The SIM 26 is a SIM that can change information stored in the SIM 26 (that is, a SIM that can rewrite information). The SIM 26 is a SIM that supports remote SIM provisioning (RSP), for example, and can change information stored in the SIM 26 by a remote operation. For example, the SIM 26 may be an embedded SIM (eSIM), or a system on a chip (Soc) integrated SIM (iSIM).

Of course, the SIM 26 may be an IC card type SIM.

A plurality of SIMs 26 may be provided in the terminal apparatus 10. For example, a plurality of eSIMs or a plurality of iSIMs may be provided in the terminal apparatus 10, or a SIM that can rewrite information (for example, eSIM or iSIM) and a SIM that cannot rewrite information may be provided in the terminal apparatus 10.

The SIM 26 corresponds to an example of “first module”. In a case where a plurality of SIMs 26 are provided in the terminal apparatus 10, one SIM 26 among the plurality of SIMs 26 corresponds to an example of “first module”, and another one SIM 26 among the plurality of SIMs 26 corresponds to an example of a “second module”.

The control unit 28 is configured to control the operation of each unit of the terminal apparatus 10.

The control unit 28 may change the communication contract information stored in the SIM 26 and cause the communication unit 20 to perform communication using the changed communication contract information. For example, in a case where a user who uses a specific place is a user who has reserved the specific place, the control unit 28 changes the communication contract information stored in the SIM 26, and causes the communication unit 20 to perform communication using the changed communication contract information, during the reservation period. The reservation period is a period during which a specific place is available by reservation. The specific place is, for example, the use place 18. For example, when the user uses the use place 18, user authentication is performed by the reservation management apparatus 12. That is, a process for checking whether or not the user who uses the use place 18 is a user who has reserved the use place 18. In a case where the user who uses the use place 18 is a user who has reserved the use place 18, the communication contract information stored in the SIM 26 is changed.

For example, category of processing concept for changing communication contract information includes to overwrite the communication contract information stored in the SIM 26 with another communication contract information, to store another communication contract information in the SIM 26 without overwriting the communication contract information stored in the SIM 26 with the other communication contract information, to overwrite the communication contract information stored in the SIM 26 with another communication contract information after storing the communication contract information stored in the SIM 26 in a storage area (for example, a storage unit 24) other than the SIM 26, and to delete the communication contract information stored in the SIM 26 and to store the other communication contract information in the SIM 26 after storing the communication contract information stored in the SIM 26 in a storage area (for example, a storage unit 24) other than the SIM 26.

Specifically, the process of changing the communication contract information includes a process of storing additional communication contract information in the SIM 26. The additional communication contract information is information for the user who has reserved the use place 18 to perform communication using the SIM 26 during the reservation period. The additional communication contract information includes a dedicated telephone number for communication during the reservation period, identification information of the SIM 26, subscriber identification information, and the like. The additional communication contract information is, for example, information different from the communication contract information stored in the SIM 26 in advance, and is information for performing communication different from the communication using the communication contract information. For example, the speed of communication using the additional communication contract information, the usage fee for the communication, the range of places where the communication can be used, and the like may be different from the communication using communication contract information stored in the SIM 26 in advance.

The additional communication contract information is information indicating a communication contract between a user who uses communication provided by the communication carrier and the communication carrier, and is, for example, information for performing communication using a mobile communication system (for example, a fourth-generation mobile communication system (that is, 4G) or a fifth-generation mobile communication system (that is, 5G)). Of course, the additional communication contract information may be information for performing communication using a communication system other than the above communication systems. For example, the additional communication contract information may be information for performing communication using Wi-Fi.

For example, the additional communication contract information is transmitted from the reservation management apparatus 12 to the terminal apparatus 10, and the control unit 28 stores the additional communication contract information transmitted from the reservation management apparatus 12 in the SIM 26.

Further, the process of changing the communication contract information stored in the SIM 26 may be performed by an apparatus other than the terminal apparatus 10. For example, the reservation management apparatus 12 may remotely change the communication contract information stored in the SIM 26 and cause the terminal apparatus 10 to perform communication using the changed communication contract information. Specifically, the reservation management apparatus 12 may remotely store the additional communication contract information in the SIM 26 and cause the terminal apparatus 10 to perform communication using the additional communication contract information. Of course, another apparatus other than the reservation management apparatus 12 may change the communication contract information stored in the SIM 26. For example, an apparatus provided in a communication carrier may change communication contract information stored in the SIM 26.

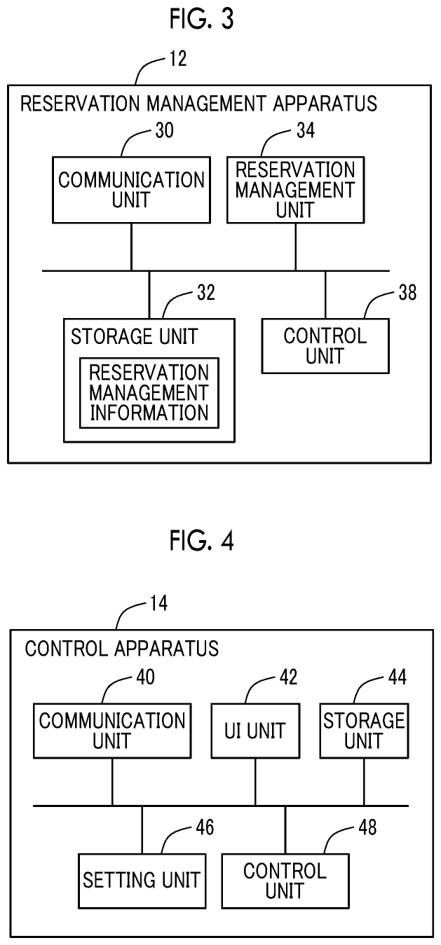

Hereinafter, with reference to FIG. 3, the configuration of the reservation management apparatus 12 will be described in detail. FIG. 3 shows an example of the configuration of the reservation management apparatus 12.

The communication unit 30 is a communication interface, and has a function of transmitting information to other apparatuses and a function of receiving information from other apparatuses. The communication unit 30 may have a wireless communication function or may have a wired communication function. The communication unit 30 may be connected to the communication path N using wireless communication or wired communication, and communicate with other apparatuses through the communication path N. Alternatively, the communication unit 20 may use near field communication and communicate with other apparatuses without passing through the communication path N.

A storage unit 32 is one or a plurality of storage areas for storing various types of information. Each storage area is configured with, for example, one or a plurality of storage devices (for example, physical drives such as a hard disk drive and a memory) provided in the reservation management apparatus 12.

The storage unit 32 stores reservation management information. The reservation management information is information for managing a reservation for use of each use place 18. The reservation management information includes, for example, use place identification information for identifying a use place 18, reservation period information indicating the reservation period of the use place 18, additional communication contract information for performing communication using the SIM 26 during the reservation period of the use place 18, user information about the user who has reserved the use place 18, use information which is information necessary for using the use place 18 during the reservation period, or the like.

The reservation management unit 34 is configured to manage a reservation for use of the use place 18. For example, the reservation management unit 34 receives a request for reservation for use of the use place 18 from the terminal apparatus 10 and registers the reservation for use of the use place 18 in the reservation management information. The reservation management unit 34 permits the user who has reserved the use place 18 to use the use place 18. In a case where a period for using the use place 18 is reserved, the reservation management unit 34 permits the user who has reserved the use place 18 to use the use place 18, during the reservation period.

The reservation management unit 34 is configured to determine additional communication contract information for performing communication using the SIM 26 during the reservation period. The additional communication contract information determined by the reservation management unit 34 is transmitted from the reservation management apparatus 12 to the terminal apparatus 10 and stored in the SIM 26.

The control unit 38 is configured to control the operation of each unit of the reservation management apparatus 12. The control unit 38 may remotely change the communication contract information stored in the SIM 26 provided in the terminal apparatus 10. For example, the control unit 38 may transmit the additional communication contract information determined by the reservation management unit 34 to the terminal apparatus 10 and store the additional communication contract information in the SIM 26. As described above, the communication contract information stored in the SIM 26 may be changed by the reservation management apparatus 12. Of course, as described above, the communication contract information stored in the SIM 26 may be changed by the terminal apparatus 10.

Hereinafter, the configuration of the control apparatus 14 will be described in detail with reference to FIG. 4. FIG. 4 shows an example of the configuration of the control apparatus 14.

The communication unit 40 is a communication interface, and has a function of transmitting information to other apparatuses and a function of receiving information from other apparatuses. The communication unit 40 may have a wireless communication function or may have a wired communication function. The communication unit 40 may be connected to the communication path N using wireless communication or wired communication, and communicate with other apparatuses through the communication path N. Alternatively, the communication unit 20 may use near field communication and communicate with other apparatuses without passing through the communication path N. The communication unit 40 communicates with the access point 16 through a wired communication path or a wireless communication path. The communication unit 40 may communicate with other apparatuses using the access point 16 through the access point 16. That is, the communication unit 40 may communicate with other apparatuses connected to the identical access point 16. The communication unit 40 may communicate with other apparatuses without passing through the access point 16. The communication unit 40 may be connected to the communication path N or other communication paths through the access point 16, or may be connected to the communication path N or other communication paths without passing through the access point 16.

A UI unit 42 is a user interface, and includes a display unit and an operation unit. The display unit is a display device such as a liquid crystal display. The operation unit is an input device such as a keyboard, input keys, or an operation panel. The UI unit 42 may be a UI unit such as a touch panel that has both a display unit and an operation unit. The UI unit 42 may not be provided in the control apparatus 14.

A storage unit 44 is one or a plurality of storage areas for storing various types of information. Each storage area is configured with, for example, one or a plurality of storage devices (for example, physical drives such as a hard disk drive and a memory) provided in the control apparatus 14.

The setting unit 46 is configured to set the wireless communication of the access point 16. The wireless communication setting includes, for example, at least one of identification information of the access point 16 or a password for using the wireless communication through the access point 16. The identification information of the access point 16 is, for example, a service set identifier (SSID). The wireless communication setting may further include at least one of whether communication with other apparatuses through wireless communication by the identical access point 16 is possible or the communication speed. The function of prohibiting communication with other apparatuses through wireless communication by the identical access point 16 is generally called an SSID client separation function, a separation function in an SSID, a privacy separator, a network separation function, or the like. The SSID client separation function is a function for prohibiting communication between apparatuses connected to the access point 16 having the identical SSID.

In a case where the use place 18 is reserved, the setting unit 46 may change the wireless communication setting of the access point 16 according to the user who has reserved the use place 18 during the reservation period at the use place 18. For example, the setting unit 46 may change the wireless communication setting of the access point 16 such that only the user who has reserved the use place 18 can communicate through the access point 16 during the reservation period. Specifically, the setting unit 46 sets the SSID and password associated with the use place 18 and the reservation period in the access point 16 during the reservation period. Thus, communication can be performed through the access point 16 using the SSID and the password during the reservation period. In a case where the reservation period ends, the setting unit 46 changes the setting of the access point 16 to the default setting, or deletes the SSID and password used during the reservation period.

The control unit 48 is configured to control the operation of each unit of the control apparatus 14. Further, in a case where a door, a gate, or the like provided with an electronic lock is provided at the use place 18, the control unit 48 may control locking and unlocking of the electronic lock.

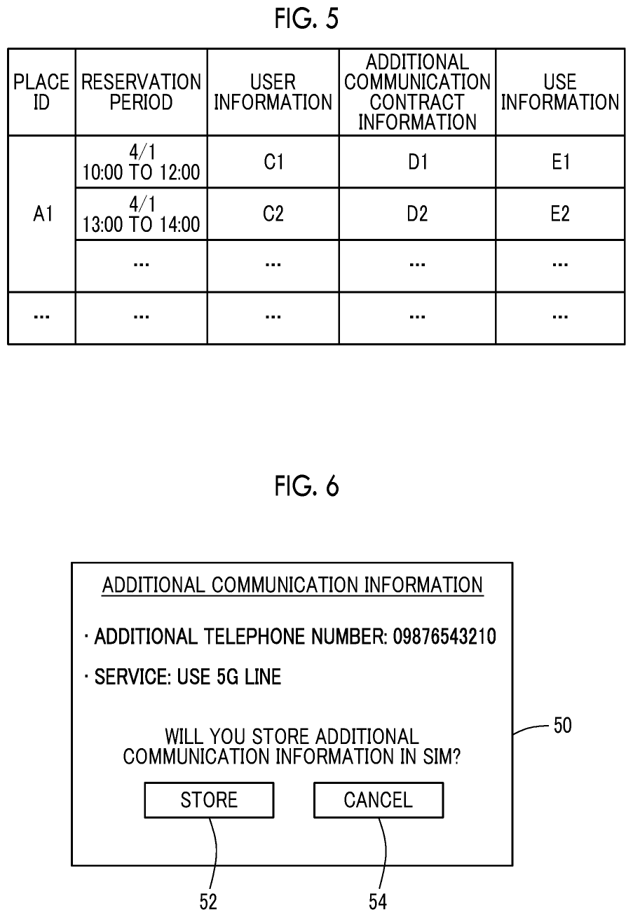

Hereinafter, an example of the reservation management information will be described with reference to FIG. 5. FIG. 5 shows an example of a reservation management table that is an example of reservation management information.

In the reservation management table, a place ID, reservation period information, user information, additional communication contract information, and use information are associated with each use place 18.

The place ID is an example of use place identification information for identifying the use place 18. The use place identification information is predetermined for each use place 18 and associated with the use place 18 in advance. The use place identification information is, for example, place ID or information indicating the name of the use place 18. Instead of the place ID, information indicating the name may be used as the use place identification information.

The reservation period information is information indicating a period during which the use place 18 is available. The reservation period is designated, for example, when the user reserves the use place 18. For example, the date and time zone at which the user uses the use place 18 is designated, and information indicating the designated date and time zone is registered in the reservation management table as reservation period information.

The user information is information related to the user who has reserved the use place 18, and includes, for example, user identification information for identifying the user who has reserved the use place 18, terminal identification information for identifying the terminal apparatus 10 used by the user, and communication contract information stored in advance in the SIM 26 provided in the terminal apparatus 10. The user identification information is information indicating a user ID, a name, an e-mail address, an account, or the like, for example. The terminal identification information is, for example, address information (for example, IP address or MAC address) or a serial number of the terminal apparatus 10. For example, when the user reserves the use place 18, the user information is transmitted from the terminal apparatus 10 used for the reservation to the reservation management apparatus 12.

The additional communication contract information is information for performing communication using the SIM 26 during the reservation period of the use place 18.

The use information is information necessary for using the use place 18 during the reservation period. The use information is information including, for example, a password and key information. In a case where the use place 18 is reserved, the use information necessary for using the use place 18 during the reservation period is generated by the reservation management unit 34, and is transmitted from the reservation management apparatus 12 to the terminal apparatus 10 used for the reservation. For example, the reservation management unit 34 generates different use information for each reservation. A user who uses the terminal apparatus 10 can use the use place 18 by using the use information. For example, in a case where an electronic lock provided at the use place 18 is locked, the use information is used to unlock the electronic lock. Further, use information may be used to indicate that the use place 18 is being used properly. For example, in a case where the use place 18 is a seat or a vehicle, use information may be used to indicate that the seat or the vehicle is being used properly. Further, use information may not be used, in a case where the use place 18 is an open space or the like, or in a case where work for using the use place 18 is unnecessary.

The reservation management table will be described with a specific example. The use place 18 having the place ID “A1” is reserved by the user C1. The reservation period is from 10:00 to 12:00 on April 1. Additional communication contract information D1 is set as additional communication contract information that is usable at this time. Further, use information E1 is set as information for using the use place 18 having the place ID “A1”.

Further, the use place 18 having the place ID “A1” is reserved by the user C2. The reservation time is from 13:00 to 14:00 on April 1. Additional communication contract information D2 is set as additional communication contract information that is usable at this time. Further, use information E2 is set as information for using the use place 18 having the place ID “A1”.

Hereinafter, a screen for performing an operation of storing additional communication contract information in the SIM 26 will be described with reference to FIG. 6. FIG. 6 shows an example of the screen.

The screen 50 is a screen for performing an operation of storing additional communication contract information that is usable during the reservation period in the SIM 26. The screen 50 is displayed, for example, after the reservation of the use place 18 is completed, during the reservation period, or before a predetermined time from the start time of the reservation period. For example, in a case where the user who uses the use place 18 is a user who has reserved the use place 18, that is, in a case where the user who uses the use place 18 is successfully authenticated, the data on the screen 50 is transmitted from the reservation management apparatus 12 to the terminal apparatus. 10, and the screen 50 is displayed on the display unit of the UI unit 22 of the terminal apparatus 10.

The reservation of the use place 18 may be performed using, for example, a Web browser, may be performed using dedicated application software for performing the reservation, or may be performed using an e-mail, chatting, or the like.

The screen 50 displays additional communication contract information that is usable during the reservation period. Here, the additional telephone number “09876543210” included in the additional communication contract information and information indicating a service that is usable using the telephone number (for example, use of a 5G line) are displayed on the screen 50.

On the screen 50, a storage button 52 is displayed. The storage button 52 is an image forgiving an instruction to store additional communication contract information in the SIM 26. In a case where the user presses the storage button 52, the additional communication contract information is stored in the SIM 26. Thus, the information stored in the SIM 26 is changed. The terminal apparatus 10 can perform communication using the additional communication contract information stored in the SIM 26.

A cancel button 54 is displayed on the screen 50. The cancel button 54 is an image for stopping writing additional communication contract information to the SIM 26. In a case where the user presses the cancel button 54, the additional communication contract information is not stored in the SIM 26.

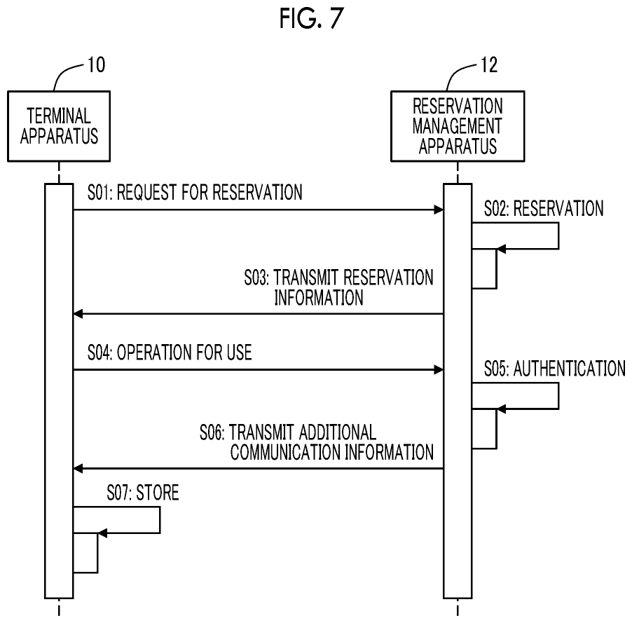

Hereinafter, with reference to FIG. 7, the process by the information processing system according to the present exemplary embodiment will be described in detail. FIG. 7 is a sequence diagram showing the flow of the process. Hereinafter, it is assumed that a booth that is a private room is used as the use place 18. The booth is provided with a door, and the door can be locked with an electronic lock. The electronic lock can be unlocked by using the above use information. The booth may be installed indoors, such as a building, or may be installed outdoors. Here, as an example, it is assumed that the user C1 reserves a booth. Further, Wi-Fi may be used by the access point 16 in and around the booth.

First, the user C1 uses the terminal apparatus 10 to request a reservation for the use of the booth that is the use place 18 (step S01).

For example, reservation application software is installed in the terminal apparatus 10. In a case where the user activates the reservation application software, the reservation application software communicates with the reservation management apparatus 12 through the communication path N, receives the data of the reservation screen transmitted from the reservation management apparatus 12, and displays the reservation screen on the display unit of the UI unit 22 of the terminal apparatus 10. For example, a list of booths and a list of reservation periods are displayed on the reservation screen. On the reservation screen, the user C1 selects a booth to be reserved from the list of booths, and selects a reservation period from the list of reservation periods. Here, it is assumed that the booth A1 having the place ID “A1” is selected and “10:00 to 12:00 on April 1” is selected as the reservation period. In a case where the booth and the reservation period are selected by the user C1, the reservation application software transmits reservation request information to the reservation management apparatus 12. The reservation request information includes information indicating the selected booth, information indicating the selected reservation period, and user information of the user C1.

Note that the user C1 may select information for identifying additional communication contract information on the reservation screen. For example, a list of information for identifying additional communication contract information that is usable during the reservation period is displayed on the reservation screen, and the user C1 may select information for identifying additional communication contract information from the list. In a case where the information for identifying the additional communication contract information is selected by the user C1, the information is also included in the reservation request information and transmitted to the reservation management apparatus 12.

Further, on the reservation screen, the user C1 may select a service that is usable using the additional communication contract information during the reservation period. For example, a service that is usable during a reservation period and additional communication contract information necessary for using the service are associated with each other in advance, and information indicating the association is stored in advance in the reservation management apparatus 12. In a case where a service is selected by the user C1, the information indicating the service is also included in the reservation request information and transmitted to the reservation management apparatus 12. In the reservation management apparatus 12, the reservation management unit 34 specifies additional communication contract information associated with the service selected by the user C1. The service is, for example, a virtual private network (VPN), communication speed improvement, data download or upload, or communication capacity increase. The user may be able to use these services by communication using the additional communication contract information during the reservation period.

The above services are services associated with the use place 18. That is, since additional communication contract information is associated with the use place 18 and a service is associated with the additional communication contract information, a service that is usable at the use place 18 is associated with the use place 18. By using the communication using the additional communication contract information, it is possible to use the service associated with the use place 18 associated with the additional communication contract information.

The reservation management unit 34 of the reservation management apparatus 12 receives the reservation request information transmitted from the terminal apparatus 10, and receives the reservation of the booth and reservation period indicated by the reservation request information (step S02).

The reservation management unit 34 registers the contents of the reservation in the reservation management table shown in FIG. 5. Here, since the booth A1 and “10:00 to 12:00 on April 1” are selected by the user C1, these contents are registered in the reservation management table.

In a case where the additional communication contract information or service is not selected by the user C1, the reservation management unit 34 determines the additional communication contract information. Specifically, the reservation management unit 34 determines additional communication contract information that is usable during the reservation period. The reservation management unit 34 may determine the additional communication contract information determined in advance by the contract with the user C1 as the additional communication contract information that is usable during the reservation period, or may determine the predetermined additional communication contract information regardless of the contract with the user C1 as the additional communication contract information that is usable during the reservation period.

Here, additional communication contract information D1 is selected by the user C1 or determined by the reservation management unit 34, as the additional communication contract information that is usable during the reservation period, and the additional communication contract information D1 is registered in the reservation management table.

In a case where the reservation is completed, the reservation management unit 34 transmits the reservation information to the terminal apparatus 10 used by the user C1 (step S03).

The reservation information includes, for example, use information used for unlocking the electronic lock of the door of the booth A1, reservation period information indicating a reservation period, and the like. The use information is, for example, key information for unlocking the electronic lock of the door. The reservation management unit 34 may change the use information for each reservation. This use information is also registered in the reservation management table. Here, the use information E1 is registered as use information for using the booth A1.

In the terminal apparatus 10, the reservation application software receives the reservation information transmitted from the reservation management unit 34.

The booth reservation and reservation information transmission and reception may be performed using a Web browser or an e-mail, without using the reservation application software.

In a case where the start time of the reservation period of the booth A1 has elapsed and the user C1 performs an operation for using the booth A1 (step S04), and user authentication for checking whether or not the use of the booth A1 by the user C1 is permitted is performed in the reservation management apparatus 12 (step S05).

For example, the door of booth A1 is locked with an electronic lock. The door is provided with a wireless communication device that performs near field communication. In a case where the user C1 brings the terminal apparatus 10 close to the door, the terminal apparatus 10 transmits the use information included in the reservation information to the wireless communication device, using near field communication. Further, the reservation information is transmitted from the reservation management apparatus 12 to the terminal apparatus 10 when the user C1 reserves the booth A1, and is stored in the storage unit 24 of the terminal apparatus 10. The wireless communication device that has received the use information from the terminal apparatus 10 transmits the use information to the control apparatus 14. The control apparatus 14 transmits the use information and use place identification information (for example, ID “A1”) of the booth A1 where the control apparatus 14 is installed to the reservation management apparatus 12. The reservation management unit 34 refers to the reservation management table shown in FIG. 5, and checks whether or not use information E1 associated with the booth A1 indicated by the use place identification information transmitted from the control apparatus 14 and the reservation period including the current date and time matches use information transmitted from the control apparatus 14. In a case where the use information transmitted from the control apparatus 14 matches the use information E1, the user authentication succeeds. In a case where the use information transmitted from the control apparatus 14 does not match the use information E1, the user authentication fails.

In a case where the use information transmitted from the control apparatus 14 is the use information E1, the reservation management unit 34 permits the use of the booth A1 by the user C1. That is, since the use information E1 is transmitted to the terminal apparatus 10 used by the user C1 at the time of reservation, in a case where the use information transmitted from the control apparatus 14 is the use information E1, it is checked that the user who attempts to use the booth A1 is the user A, and the user authentication succeeds. In this case, the reservation management unit 34 transmits information indicating an unlocking instruction to the control apparatus 14. The control unit 48 of the control apparatus 14 unlocks the electronic lock according to the unlocking instruction. In a case where the electronic lock is unlocked, the user C1 can open the door and enter the booth A1. Further, the reservation management unit 34 transmits information indicating the start of use of the booth A1 to the control apparatus 14.

Further, the reservation management unit 34 refers to the reservation management table, and specifies the additional communication contract information associated with the booth A1 indicated by the use place identification information transmitted from the control apparatus 14 and the reservation period including the current date and time, and the control unit 38 transmits the additional communication contract to the terminal apparatus 10 used by the user C1 (step S06). For example, the communication contract information stored in advance in the SIM 26 provided in the terminal apparatus 10 used by the user C1 is registered in the reservation management table by being included in the user information, when the booth A1 is reserved. The control unit 38 transmits the additional communication contract information to the terminal apparatus 10 used by the user C1 through communication using the communication contract information registered in the reservation management table. That is, the terminal apparatus 10 communicates with the reservation management apparatus 12 using the communication contract information stored in advance in the SIM 26 and receives additional communication contract information from the reservation management apparatus 12.

The control unit 28 of the terminal apparatus 10 used by the user C1 stores the additional communication contract information in the SIM 26 (step S07). Thereby, the terminal apparatus 10 can perform communication using the additional communication contract information during the reservation period. Note that the control unit 38 of the reservation management apparatus 12 may remotely store the additional communication contract information in the SIM 26. In a case where the reservation period elapses, the terminal apparatus 10 cannot perform communication using the additional communication contract information. For example, in the communication carrier, the additional communication contract information is registered as information that is usable during the reservation period. For example, in a case where the reservation period elapses, the communication carrier cuts off communication using the additional communication contract information. By doing so, the terminal apparatus 10 cannot perform communication using the additional communication contract information. As another example, in a case where the reservation period elapses, the additional communication contract information may be automatically deleted from the SIM 26. By doing so, the terminal apparatus 10 cannot perform communication using the additional communication contract information.

The additional communication contract information may be displayed on the display unit of the UI unit 22 of the terminal apparatus 10 used by the user C1. For example, the screen 50 shown in FIG. 6 is displayed on the display unit of the UI unit 22. In a case where the user presses the storage button 52, the additional communication contract information is stored in the SIM 26. For example, in a case where the user presses the storage button 52, information indicating a request for additional communication contract information is transmitted from the terminal apparatus 10 to the reservation management apparatus 12. The reservation management unit 34 transmits additional communication contract information to the terminal apparatus 10 in response to the request. The additional communication contract information transmitted to the terminal apparatus 10 is stored in the SIM 26. In a case where the user presses the cancel button 54, the additional communication contract information is not transmitted from the reservation management apparatus 12 to the terminal apparatus 10. Of course, in a case where the user authentication is successful, before the user presses the storage button 52, the additional communication contract information is transmitted from the reservation management apparatus 12 to the terminal apparatus 10 and temporarily stored in the storage unit 24, and in a case where the user presses the storage button 52, the additional communication contract information may be stored in the SIM 26. In this case, in a case where the user presses the cancel button 54, the additional communication contract information is deleted from the storage unit 24 without being stored in the SIM 26.

In a case where the use information transmitted from the control apparatus 14 is different from the use information E1, that is, in a case where the user authentication fails, the reservation management unit 34 does not permit the use of the booth A1 by the user C1. In this case, the reservation management unit 34 does not transmit information indicating the unlocking instruction to the control apparatus 14. Further, the additional communication contract information is not transmitted from the reservation management apparatus 12 to the terminal apparatus 10, and the terminal apparatus 10 cannot perform communication using the additional communication contract information.

For example, in a case where the current date and time is a time from 10:00 to 12:00 on April 1, and the use information transmitted from the control apparatus 14 is identical to the use information E1, the reservation management unit 34 permits the use of the booth A1 by the user C1. In a case where the current date and time is a time from 10:00 to 12:00 on April 1, and the use information transmitted from the control apparatus 14 is different from the use information E1, the reservation management unit 34 does not permit the use of the booth A1 by the user C1. Even in a case where the transmitted use information is identical to the use information E1, in a case where the current date and time is date and time other than 10:00 to 12:00 on April 1, the reservation management unit 34 does not permit the use of the booth A1 by the user C1.

Information other than use information may be used for user authentication. For example, user identification information and terminal identification information included in the user information may be used. For example, in a case where the user C1 brings the terminal apparatus 10 close to the door, the terminal apparatus 10 transmits to the wireless communication device, all or part of the user information stored in the terminal apparatus 10 (for example, user identification information for identifying the user C1 and terminal identification information for identifying the terminal apparatus 10) together with the use information included in the reservation information, using near field communication. All or part of the user information and the use information are transmitted to the reservation management apparatus 12 through the control apparatus 14. In a case where all or part of the user information transmitted from the terminal apparatus 10 and the use information are registered in the reservation management table, the user authentication is successful. In a case where all or part of the user information transmitted from the terminal apparatus 10 and the use information are not registered in the reservation management table, the user authentication fails. The processing after user authentication is identical to the processing after step S06.

Since the additional communication contract information is stored in the SIM 26, the information stored in the SIM 26 is rewritten, and as a result, in a case where communication cannot be performed using the communication contract information originally stored in the SIM 26, information to that effect may be displayed on the terminal apparatus 10 used by the communication partner, or a voice representing the information to that effect may be emitted. For example, a message such as “cannot talk or communicate during the reservation period (for example, 10:00 to 12:00)” may be transmitted from the terminal apparatus 10 or the communication carrier in which the information in the SIM 26 is rewritten, to the terminal apparatus 10 of the other party who has called the terminal apparatus 10. Further, a part of the additional communication contract information may be transmitted from the terminal apparatus 10 or the communication carrier in which the information in the SIM 26 is rewritten, to the terminal apparatus 10 of the other party who has called the terminal apparatus 10. For example, a message such as “The telephone number that is usable for calling is ************” may be transmitted.

Hereinafter, the process by the information processing system according to the present exemplary embodiment will be described with specific examples.

### Example 1

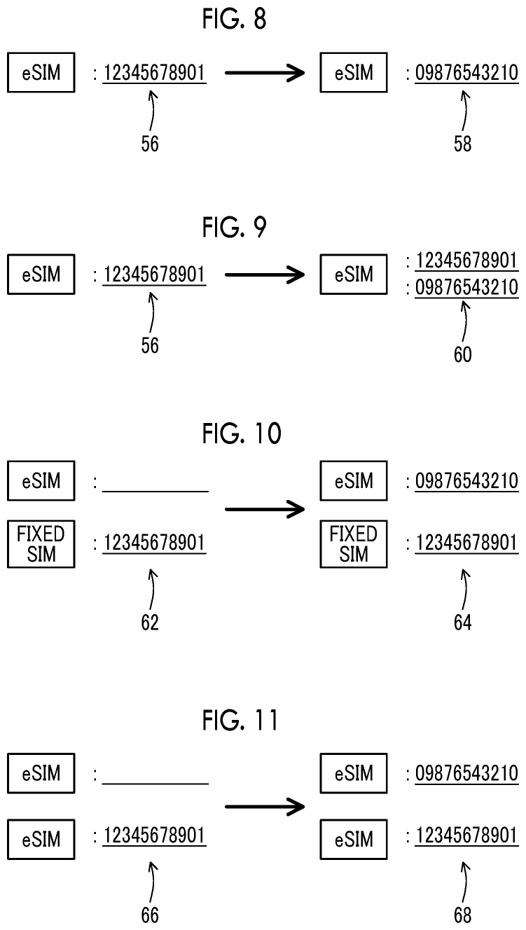

With reference to FIG. 8, Example 1 will be described. FIG. 8 shows an example of information stored in the SIM 26.

In Example 1, as an example, one eSIM is used as the SIM 26. That is, one eSIM is provided in the terminal apparatus 10.

As indicated by reference numeral 56, communication contract information is stored in the eSIM in advance. FIG. 8 shows a telephone number “12345678901” included in the communication contract information. The terminal apparatus 10 can communicate using communication contract information stored in the eSIM.

The additional communication contract information is acquired by communication using the communication contract information stored in advance in the eSIM. That is, the terminal apparatus 10 acquires additional communication contract information from the reservation management apparatus 12 through communication using the communication contract information stored in advance in the eSIM. The additional communication contract information acquired in this way is stored in the eSIM.

As indicated by reference numeral 58, the acquired additional communication contract information is stored in the eSIM. FIG. 8 shows a telephone number “09876543210” included in the additional communication contract information. In a case where the user who uses the use place 18 is a user who has reserved the use place 18, the terminal apparatus 10 can communicate using the additional communication contract information stored in the eSIM during the reservation period. Further, the terminal apparatus 10 can use a service associated with the use place 18.

The control unit 28 of the terminal apparatus 10 may store the additional communication contract information in the eSIM by overwriting the communication contract information with the additional communication contract information acquired as described above. That is, the control unit 28 rewrites the information stored in the eSIM. In this case, the control unit 28 stores the communication contract information originally stored in the eSIM in a storage other than the eSIM (for example, the storage unit 24, the reservation management apparatus 12, a server, or the like). In a case where the reservation period has elapsed, the control unit 28 acquires communication contract information stored in a storage other than the eSIM (for example, the storage unit 24, the reservation management apparatus 12, or a server) from the storage, and stores the communication contract information in the eSIM by overwriting the additional communication contract information stored in the eSIM with the acquired communication contract information. That is, the control unit 28 rewrites the information stored in the eSIM. By doing so, after the reservation period elapses, the terminal apparatus 10 can communicate using the communication contract information but stored in advance in the eSIM. Further, the control unit 38 of the reservation management apparatus 12 may perform the above processing remotely.

The additional communication contract information acquired as described above may be stored in the eSIM without overwriting the communication contract information with the additional communication contract information. For example, in a case where the eSIM has a storage capacity for storing both the communication contract information and the additional communication contract information, the control unit 28 of the terminal apparatus 10 does not overwrite the communication contract information with the additional communication contract information, and stores the additional communication contract information in the eSIM. Thereby, as indicated by reference numeral 60 in FIG. 9, both the communication contract information and the additional communication contract information are stored in the eSIM. In a case where the user who uses the use place 18 is a user who has reserved the use place 18, the terminal apparatus 10 can communicate using the additional communication contract information during the reservation period. During the reservation period, the terminal apparatus 10 may communicate using information selected by the user from the communication contract information and the additional communication contract information. In a case where the reservation period has elapsed, the control unit 28 deletes the additional communication contract information from the eSIM. By doing so, after the reservation period elapses, the terminal apparatus 10 cannot communicate using the additional communication contract information but can communicate using the communication contract information. Note that the additional communication contract information may not be deleted even after the reservation period elapses, and communication using the additional communication contract information may be prohibited. Further, the control unit 38 of the reservation management apparatus 12 may perform the above processing remotely.

### Example 2

With reference to FIG. 10, Example 2 will be described. FIG. 10 shows an example of information stored in the SIM 26.

In Example 2, as an example, a plurality of SIMs are provided in the terminal apparatus 10. As illustrated in FIG. 10, for example, one eSIM which is an example of the SIM 26 and one fixed SIM are provided in the terminal apparatus 10. The fixed SIM is a SIM that cannot change the information stored in the fixed SIM. For example, a fixed SIM is a SIM that does not support RSP.

As indicated by reference numeral 62, communication contract information is stored in advance in the fixed SIM, and communication contract information and additional communication contract information are not stored in the eSIM. FIG. 10 shows a telephone number “12345678901” included in the communication contract information. The terminal apparatus 10 can communicate using communication contract information stored in the fixed SIM.

The additional communication contract information is acquired by communication using the communication contract information stored in advance in the fixed SIM. That is, the terminal apparatus 10 acquires additional communication contract information from the reservation management apparatus 12 through communication using the communication contract information stored in advance in the fixed SIM. The additional communication contract information acquired in this way is stored in the eSIM.

As indicated by reference numeral 64, the acquired additional communication contract information is stored in the eSIM. FIG. 10 shows a telephone number “09876543210” included in the additional communication contract information. In a case where the user who uses the use place 18 is a user who has reserved the use place 18, the terminal apparatus 10 can communicate using the additional communication contract information stored in the eSIM during the reservation period. Further, the terminal apparatus 10 can use a service associated with the additional communication contract information.

During the reservation period, the terminal apparatus 10 may communicate using information selected by the user from the communication contract information stored in the fixed SIM and the additional communication contract information stored in the eSIM.

In a case where the reservation period has elapsed, the control unit 28 of the terminal apparatus 10 or the control unit 38 of the reservation management apparatus 12 deletes the additional communication contract information stored in the eSIM. Thereafter, the terminal apparatus 10 can no longer communicate using the additional communication contract information, and communicates using the communication contract information stored in the fixed SIM.

FIG. 11 shows another example of Example 2. In this example, two eSIMs are provided in the terminal apparatus 10.

As indicated by reference numeral 66, communication contract information is stored in advance in one eSIM, and communication contract information and additional communication contract information are not stored in the other eSIM. FIG. 11 shows a telephone number “12345678901” included in the communication contract information. The terminal apparatus 10 can communicate by using communication contract information stored in one eSIM.

The additional communication contract information is acquired by communication using the communication contract information stored in advance in one eSIM. That is, the terminal apparatus 10 acquires additional communication contract information from the reservation management apparatus 12 through communication using the communication contract information stored in advance in one eSIM. The additional communication contract information acquired in this way is stored in the eSIM.

As indicated by reference numeral 68, the acquired additional communication contract information is stored in the other eSIM. FIG. 11 shows a telephone number “09876543210” included in the additional communication contract information. In a case where the user who uses the use place 18 is a user who has reserved the use place 18, the terminal apparatus 10 can communicate using the additional communication contract information stored in the other eSIM during the reservation period. Further, the terminal apparatus 10 can use a service associated with the additional communication contract information.

During the reservation period, the terminal apparatus 10 may communicate using information selected by the user from the communication contract information stored in one eSIM and the additional communication contract information stored in the other eSIM.

In a case where the reservation period has elapsed, the control unit 28 of the terminal apparatus 10 or the control unit 38 of the reservation management apparatus 12 deletes the additional communication contract information stored in the other eSIM. Thereafter, the terminal apparatus 10 can no longer communicate using the additional communication contract information, and communicates using the communication contract information stored in one eSIM.

Hereinafter, modification examples will be described.

### Modification Example 1

The communication using the additional communication contract information may be communication that is usable at the use place 18 that is a specific place. The use place 18 is a place reserved by the user as described above. For example, a service provided by communication using additional communication contract information can be used only at the use place 18.

For example, the control unit 28 of the terminal apparatus 10 acquires position information indicating the position of the terminal apparatus 10 by using a global positioning system (GPS). In a case where the position of the terminal apparatus 10 is a position within the use place 18, the control unit 28 permits communication using the additional communication contract information. Thereby, the terminal apparatus 10 can communicate using the additional communication contract information at the use place 18. Even in this case, the terminal apparatus 10 can communicate using the additional communication contract information during the reservation period. In a case where the position of the terminal apparatus 10 is a position outside the use place 18, the control unit 28 does not permit communication using the additional communication contract information. Thereby, the terminal apparatus 10 cannot communicate using the additional communication contract information.

The determination as to whether or not to permit communication using the additional communication contract information may be performed by the control unit 38 of the reservation management apparatus 12 or may be performed by a communication carrier. In this case, the terminal apparatus 10 transmits the position information of the terminal apparatus 10 to the reservation management apparatus 12 or the communication carrier. The reservation management apparatus 12 or the communication carrier determines whether or not the position of the terminal apparatus 10 is a position within the use place 18, based on the position information transmitted from the terminal apparatus 10. In a case where the position of the terminal apparatus 10 is a position within the use place 18, the reservation management apparatus 12 or the communication carrier permits communication using the additional communication contract information. Information indicating the permission is transmitted from the reservation management apparatus 12 or the communication carrier to the terminal apparatus 10, and the terminal apparatus 10 can communicate using the additional communication contract information. In a case where the position of the terminal apparatus 10 is a position outside the use place 18, the reservation management apparatus 12 or the communication carrier does not permit communication using the additional communication contract information. Information indicating the non-permission is transmitted from the reservation management apparatus 12 or the communication carrier to the terminal apparatus 10, and the terminal apparatus 10 cannot communicate using the additional communication contract information.

### Modification Example 2

The communication using the additional communication contract information may be a communication that is usable at the use place 18 that is a specific place and at another use place related to the use place 18. The use place 18 is a place reserved by the user as described above. The other use place is a place associated with the use place 18 in advance as a place related to the use place 18. Information indicating the association may be stored, for example, in the reservation management apparatus 12 or the communication carrier, or may be stored in the terminal apparatus 10. For example, a service provided by communication using the additional communication contract information can be used only at the use place 18 and the other use place.

For example, the control unit 28 of the terminal apparatus 10 acquires position information indicating the position of the terminal apparatus 10 by using a GPS. In a case where the position of the terminal apparatus 10 is a position within the use place 18 or another use place related to the use place, the control unit 28 permits communication using the additional communication contract information. Thereby, the terminal apparatus 10 can communicate using the additional communication contract information at the use place 18 or the other use place. Even in this case, the terminal apparatus 10 can communicate using the additional communication contract information during the reservation period. In a case where the position of the terminal apparatus 10 is a position outside the use place 18 or a position outside another use place related to the use place 18, the control unit 28 does not permit communication using the additional communication contract information. Thereby, the terminal apparatus 10 cannot communicate using the additional communication contract information.

In Modification Example 2, as in Modification Example 1, the reservation management apparatus 12 or the communication carrier may determine whether to permit communication using the additional communication contract information.

### Modification Example 3

In Modification Example 3, other users other than the user who has reserved the use place 18 can communicate using the additional communication contract information. That is, the additional communication contract information is stored in the SIM 26 provided in the other terminal apparatus 10 used by the other user, and the other terminal apparatus 10 can communicate using the additional communication contract information during the reservation period.

For example, the additional communication contract information is transmitted from the reservation management apparatus 12 to another terminal apparatus 10 used by another user, and stored in the SIM 26 provided in the other terminal apparatus 10.

Another user is a user associated with the user who has reserved the use place 18. For example, another user is a user that is registered in the reservation management apparatus 12 by the user who has reserved the use place 18 at the time of reservation of the use place 18. Further, the user who has reserved the use place 18 may register another user or exclude other registered users from registration until the reservation period ends after the reservation.

In the reservation management table according to Modification Example 3, in addition to the information registered in the reservation management table shown in FIG. 5, other user information is associated with a place ID or the like for each use place 18.

The other user information is information related to other users other than the user who has reserved the use place 18, and information related to the other users who are permitted to use the additional communication contract information that is usable by the user who has reserved the use place 18. For example, the communication contract information stored in advance in the SIM 26 provided in the terminal apparatus 10 used by another user is included in the other user information. The other user information is registered, for example, by the user who has reserved the use place 18.

In step S05 shown in FIG. 7, in a case where the authentication of the user who has reserved the use place 18 is successful, the additional communication contract information is transmitted by communication using the communication contract information of the user who has reserved the use place 18, from the reservation management apparatus 12 to the terminal apparatus 10 used by the user who has reserved the use place 18. The additional communication contract information is stored in the SIM 26 provided in the terminal apparatus 10 used by the user. Thereby, the terminal apparatus 10 used by the user can communicate using the additional communication contract information during the reservation period. Further, the additional communication contract information is transmitted from the reservation management apparatus 12 to another terminal apparatus 10 used by the other user by communication using the communication contract information of another user associated with the user who has reserved the use place 18. The additional communication contract information is stored in the SIM 26 provided in the other terminal apparatus 10. Thereby, the other terminal apparatus 10 can communicate using the additional communication contract information during the reservation period.

### Modification Example 4

In a case where the SIM 26 provided in the terminal apparatus 10 is a SIM that is not permitted to change the information stored in the SIM 26, the reservation management unit 34 of the reservation management apparatus 12 may transmit information for communication through a specific communication path to the terminal apparatus 10, without changing the information stored in the SIM 26. The SIM 26 that is not permitted to change information is not an eSIM or iSIM, and is a SIM that does not support RSP. The specific communication path is, for example, a communication path that uses the access point 16 at the use place 18.

For example, when the user reserves the use place 18, the terminal apparatus 10 used by the user transmits information related to the SIM 26 provided in the terminal apparatus 10 to the reservation management apparatus 12. The information related to the SIM 26 includes information indicating whether or not the SIM 26 is a SIM that is permitted to change information. Information related to the SIM 26 is associated with the user information and registered in the reservation management information (for example, the reservation management table shown in FIG. 5). In a case where the SIM 26 is a SIM that is not permitted to change information, the reservation management unit 34 registers the wireless setting information for using the access point 16 of the reserved use place 18, instead of the additional communication contract information, in the reservation management information (for example, the reservation management table shown in FIG. 5) in association with the place ID, the reservation period, and the user information. The wireless setting information includes the SSID and password of the access point 16 and other setting information (for example, whether or not the SSID client separation function is set). In a case where the SIM 26 is a SIM that is permitted to change information, the additional communication contract information is registered in the reservation management information as in the above-described exemplary embodiment.

In step S05 shown in FIG. 7, in a case where authentication of the user who has reserved the use place 18 is successful, the SIM 26 provided in the terminal apparatus 10 used by the user is a SIM that is not permitted to change information (that is, in a case where information indicating that the SIM 26 is a SIM that is not permitted to change information is registered in the reservation management information), the reservation management unit 34 transmits the wireless setting information registered in the reservation management information to the terminal apparatus 10. The wireless setting information is displayed on the display unit of the UI unit 22 of the terminal apparatus 10. Specifically, an SSID, a password and the like for using the access point 16 at the use place 18 are displayed. Further, the reservation management unit 34 transmits the wireless setting information to the control apparatus 14 at the use place 18. The setting unit 46 of the control apparatus 14 sets the wireless communication of the access point 16 at the use place 18 according to the wireless setting information. Specifically, the setting unit 46 sets an SSID, a password, and the like in the access point 16. The user refers to the SSID and password displayed on the display unit of the UI unit 22 and sets the terminal apparatus 10. Thereby, the terminal apparatus 10 can communicate through the access point 16 at the use place 18. For example, the terminal apparatus 10 can use Wi-Fi or the like.

The functions of the respective units of the terminal apparatus 10, the reservation management apparatus 12, and the control apparatus 14 are realized by, for example, cooperation of hardware and software. Specifically, the terminal apparatus 10, the reservation management apparatus 12, and the control apparatus 14 include one or a plurality of processors such as a CPU (not shown). The functions of the respective units of the terminal apparatus 10, the reservation management apparatus 12, and the control apparatus 14 are realized by the one or a plurality of processors reading and executing the program stored in the storage device (not shown). The program is stored in a storage device through a recording medium such as a CD or a DVD or through a communication path such as a network. As another example, the functions of the respective units of the terminal apparatus 10, the reservation management apparatus 12, and the control apparatus 14 may be realized by hardware resources such as a processor, an electronic circuit, an application specific integrated circuit (ASIC), or the like. A device such as a memory may be used for realizing the device. As still another example, the functions of the respective units of the terminal apparatus 10, the reservation management apparatus 12, and the control apparatus 14 may be realized by a digital signal processor (DSP), a field programmable gate array (FPGA), or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a control section that in a case where a user who uses a specific place is a user who has reserved the specific place, changes communication contract information of a terminal apparatus used by the user, and causes the terminal apparatus to perform communication using the changed communication contract information, during a period of the reservation.

2. The information processing apparatus according to claim 1,
wherein the terminal apparatus includes a first module that stores the communication contract information to be used for communication,
wherein the processing of changing the communication contract information includes processing of storing additional communication contract information for communication using the first module during the period of the reservation in the first module, and
wherein the control section causes the terminal apparatus to perform communication using the additional communication contract information during the period of the reservation.

3. The information processing apparatus according to claim 2,
wherein the first module stores the communication contract information in advance, and
wherein the additional communication contract information is acquired by communication using the communication contract information stored in advance in the first module, and is stored in the first module.

4. The information processing apparatus according to claim 3,
wherein the control section stores the additional communication contract information in the first module, by overwriting the communication contract information with the additional communication contract information, and stores the communication contract information in a storage section other than the first module.

5. The information processing apparatus according to claim 4,
wherein in a case where the period of the reservation elapses, the control section stores the communication contract information in the first module by overwriting the communication contract information stored in the storage section with the additional communication contract information.

6. The information processing apparatus according to claim 2,
wherein in a case where the period of the reservation elapses, the control section deletes the additional communication contract information from the first module.

7. The information processing apparatus according to claim 2,
wherein the terminal apparatus includes the first module and a second module different from the first module, and
wherein the control section stores the additional communication contract information in the second module by using communication using the first module.

8. The information processing apparatus according to claim 2,
wherein the communication using the additional communication contract information is communication that is usable in the specific place.

9. The information processing apparatus according to claim 3,
wherein the communication using the additional communication contract information is communication that is usable in the specific place.

10. The information processing apparatus according to claim 4,
wherein the communication using the additional communication contract information is communication that is usable in the specific place.

11. The information processing apparatus according to claim 5,
wherein the communication using the additional communication contract information is communication that is usable in the specific place.

12. The information processing apparatus according to claim 6,
wherein the communication using the additional communication contract information is communication that is usable in the specific place.

13. The information processing apparatus according to claim 7,
wherein the communication using the additional communication contract information is communication that is usable in the specific place.

14. The information processing apparatus according to claim 2,
wherein the communication using the additional communication contract information is communication that is usable in the specific place and another place related to the specific place.

15. The information processing apparatus according to claim 3,
wherein the communication using the additional communication contract information is communication that is usable in the specific place and another place related to the specific place.

16. The information processing apparatus according to claim 4,
wherein the communication using the additional communication contract information is communication that is usable in the specific place and another place related to the specific place.

17. The information processing apparatus according to claim 2,
wherein the additional communication contract information is transmitted to another terminal apparatus used by another user associated with the user.

18. The information processing apparatus according to claim 2,
wherein in a case where the first module is a module that is not permitted to change information stored in the first module, the control section outputs information for communication through a specific communication path to the terminal apparatus, without changing the information stored in the first module.

19. The information processing apparatus according to claim 1,
wherein a service associated with the place is available by communication using the changed communication contract information during the period of the reservation.

20. A non-transitory computer readable medium storing a program causing a computer to function as:
a control section that in a case where a user who uses a specific place is a user who has reserved the specific place, changes communication contract information of a terminal apparatus used by the user, and causes the terminal apparatus to perform communication using the changed communication contract information, during a period of the reservation.
